(19) United States
(12) Patent Application Publication
(10) Pub. No.: US 2024/0101021 A1
(43) Pub. Date: Mar. 28, 2024

(54) HEADLIGHT DETERMINATION APPARATUS

(71) Applicant: Honda Motor Co., Ltd., Tokyo (JP)

(72) Inventors: Fumihiro YASUFUKU, Saitama (JP); Kazuki KAWAMURA, Tokyo (JP); Kazuki ODAGIRI, Tokyo (JP); Keisuke MAEDA, Tokyo (JP); Takashi MAI, Tochigi (JP); Takafumi OTA, Tokyo (JP)

(73) Assignee: Honda Motor Co., Ltd., Tokyo (JP)

(21) Appl. No.: 18/357,185

(22) Filed: Jul. 24, 2023

(30) Foreign Application Priority Data
Sep. 23, 2022 (CN) 202211163433.X

(51) Int. Cl. B60Q 1/14; B60Q 1/00

(52) U.S. Cl. CPC B60Q 1/143; B60Q 1/0023; B60Q 2300/054; B60Q 2300/314

(57) ABSTRACT

A headlight determination apparatus includes a camera device, a target light recognition device, and a changing device. The camera device captures an image ahead of a vehicle at a predetermined frame rate. The target light recognition device recognizes target light from the image captured by the camera device. The changing device changes a wavelength of headlight of the vehicle by using a predetermined period slower than the predetermined frame rate. When the wavelength of the headlight is different from a wavelength of the target light and/or when a period of the wavelength of the headlight does not match a period of the wavelength of the target light, the target light recognition device recognizes that there is target light other than the headlight in front of the vehicle and controls light distribution of the headlight when there is target light other than the headlight in front of the vehicle.

### CROSS-REFERENCE TO RELATED APPLICATION

This application claims the priority benefit of China application serial no. 202211163433.X, filed on Sep. 23, 2022. The entirety of the above-mentioned patent application is hereby incorporated by reference herein and made a part of this specification.

### BACKGROUND

### Technical Field

The disclosure relates to a headlight determination apparatus, and in particular, to a headlight determination apparatus that recognizes target light to change the light distribution of the headlight.

### Description of Related Art

When driving a vehicle on a dark road, the driver usually switches the headlight to high beam in order to see the road conditions ahead. In such a situation, if there is an oncoming vehicle ahead, the light of the high beam will cause glare to the driver of the vehicle ahead.

The automatic high beam (AHB) technology is used to automatically turn off the high beam when the camera detects that there is a vehicle ahead, so as to prevent the high beam from causing glare to the driver of the vehicle ahead, but it will automatically turn on the high beam if there is no vehicle ahead. As shown in FIG. 1, after a vehicle 10 starts the AHB, in addition to turning on the low beam, it will also turn on the high beam. But after detecting an oncoming vehicle 20, the vehicle 10 will automatically turn off the high beam, so as to avoid the high beam from causing glare to the driver of the oncoming vehicle 20.

Adaptive driving beam (ADB) is a variable light distribution technology. When the camera detects a vehicle ahead, the light can be automatically adjusted. Further, only the high beam corresponding to the position of the vehicle ahead is automatically turned off, so the high beam is prevented from causing glare to the driver of the vehicle ahead, and long-distance visibility is also improved As shown in FIG. 2, after activating the ADB, the vehicle 10 can automatically adjust the light when it detects the oncoming vehicle 20, only automatically turns off the high beam corresponding to the position of the vehicle ahead, and moves the high beams downwards or laterally to prevent the high beams from irradiating the oncoming vehicle 20 and causing glare to the driver.

The AHB technology and the ADB technology will automatically turn off the high beam in bright urban areas where there are street lights and the like around.

At night, an arrow-feather traffic sign mounted in the snow reflects the light from the headlight, making it look like a street light. As a result, the camera mistakes the arrow-feather traffic sign for a street light, and it is thus determined that the vehicle is driving on an urban road, and the high beam is then turned off.

Patent literature 1 (Japanese Patent Publication No. 2015-9570) discloses a headlight control device capable of identifying reflected light of a headlight of the vehicle from other light sources. By setting the frame rate of the camera relatively higher than the switching period of the headlight and by comparing the frequency of the headlight of the vehicle with the frequency of the reflector detected by the camera, the signal (switching of the headlight) generated by the controller can be properly detected. With current technology, however, it is difficult to compare the frequency of headlight to the camera due to the capabilities of the imaging element of the camera (typically 30 frames per second). For instance, if the frequency of the headlight is 500 hertz (hz), that is, it is turned on and off at the rate of 2 milliseconds in one second, to accurately capture this, a camera with 1000 frames per second is required. Therefore, it is practically difficult to implement the method of comparing headlight frequencies.

In a currently-available headlight control apparatus, unless the camera has a frame rate sufficiently faster than the on-off period of the headlight, the reflected light from the headlight of the vehicle itself cannot be distinguished from other light sources.

In the disclosure, by changing the current value of the headlight to change the color tone, the light source of the vehicle can be recognized even at the current frame rate of the camera.

In the disclosure, by changing the current value of the headlight to change the color, even if the frame rate of the camera is slower than the period of the headlight, the reflected light of the headlight of the vehicle itself and other light sources may still be distinguished.

### SUMMARY

The disclosure provides a headlight determination apparatus including a camera device, a target light recognition device, and a changing device. The camera device is configured to capture an image ahead of a vehicle at a predetermined frame rate. The target light recognition device is configured to recognize target light from the image captured by the camera device. The changing device is configured to change a wavelength of headlight of the vehicle by using a predetermined period slower than the predetermined frame rate. When the wavelength of the headlight is different from a wavelength of the target light and/or when a period of the wavelength of the headlight does not match a period of the wavelength of the target light, the target light recognition device determines that there is target light other than the headlight in front of the vehicle and controls light distribution of the headlight when there is target light other than the headlight in front of the vehicle.

In order to make the disclosure more comprehensible, the following specific embodiments are described in detail with accompanying drawings.

### BRIEF DESCRIPTION OF THE DRAWINGS

FIG. 1 is a schematic view of a known auto high beam technology.

FIG. 2 is a schematic view of a known adaptive driving beam technology.

FIG. 3 is a block view of a headlight determination apparatus according to an embodiment of the disclosure.

FIG. 4 is a flow chart of a headlight determination method according to an embodiment of the disclosure.

FIG. 5 and FIG. 6 are examples of the headlight determination method according to an embodiment of the disclosure.

FIG. 7 is a flow chart of a headlight determination method according to an embodiment of the disclosure.

FIG. 8 is an example of distinguishing street light and a reflective object according to an embodiment of the disclosure.

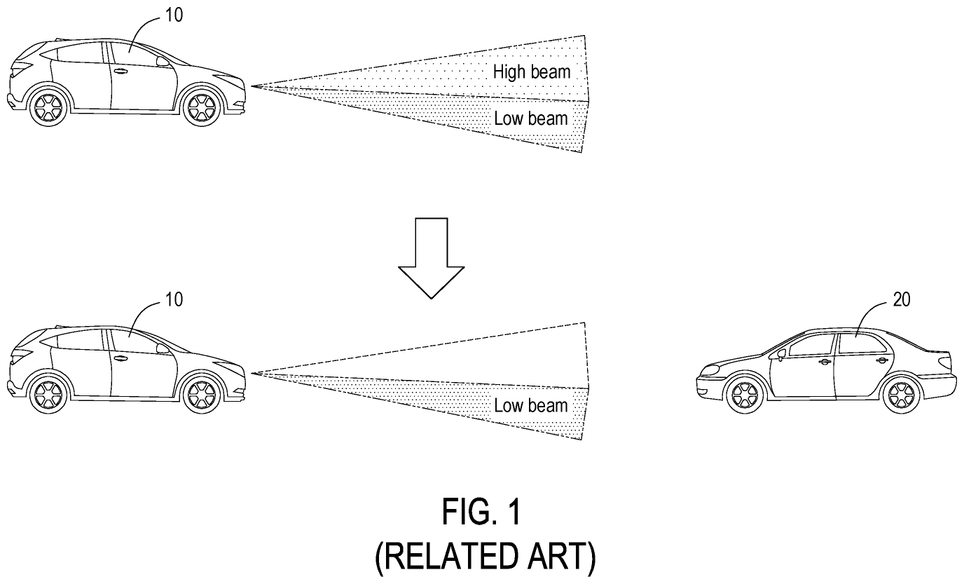

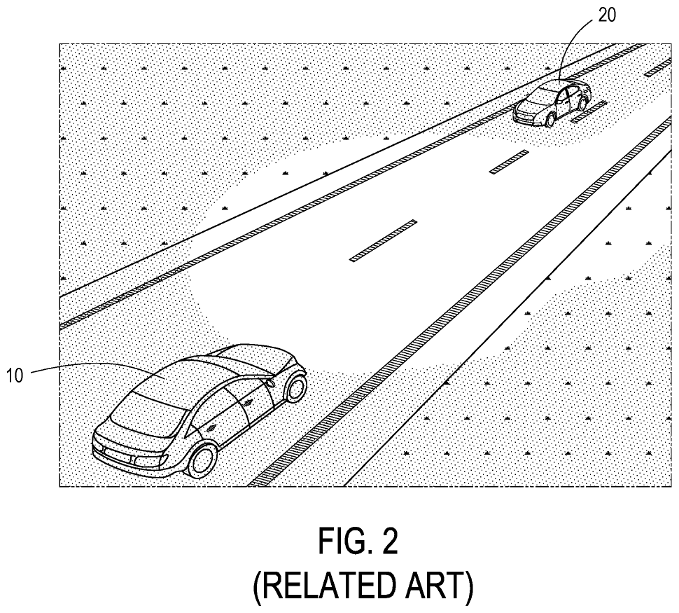

### DESCRIPTION OF THE EMBODIMENTS

Hereinafter, the embodiments of the disclosure are described with reference to the accompanying drawings.

The disclosure provides a headlight determination apparatus including a camera device, a target light recognition device, and a changing device. The camera device is configured to capture an image ahead of a vehicle at a predetermined frame rate. The target light recognition device is configured to recognize target light from the image captured by the camera device. The changing device is configured to change a wavelength of headlight of the vehicle by using a predetermined period slower than the predetermined frame rate. When the wavelength of the headlight is different from a wavelength of the target light and/or when a period of the wavelength of the headlight does not match a period of the wavelength of the target light, the target light recognition device determines that there is target light other than the headlight in front of the vehicle and controls light distribution of the headlight when there is target light other than the headlight in front of the vehicle.

In an embodiment of the disclosure, the changing device of the headlight determination apparatus changes a color by changing a current value of the headlight.

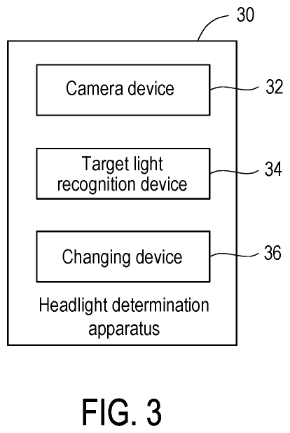

FIG. 3 is a block view of a headlight determination apparatus according to an embodiment of the disclosure.

As shown in FIG. 3, a headlight determination apparatus 30 includes a camera device 32, a target light recognition device 34, and a changing device 36.

The camera device 32 includes a photosensitive element for sensing intensity of incident light to generate an image. The photosensitive element is, for example, a charge coupled device (CCD), a complementary metal-oxide semiconductor (CMOS) element, or other elements. In a vehicle, the camera device 32 is installed, for example, on an upper part of a windshield, on a back surface of an interior rear-view mirror, or inside or around a headlamp and the like, to capture an image in front of the vehicle. The camera device 32, for example, periodically captures images in front of the vehicle for output to the target light recognition device 34.

Part or all of the target light recognition device 34 and the changing device 36 are implemented by executing programs or software by a processor such as a central processing unit (CPU) or a graphics processing unit (GPU). In some embodiments, part or all of the target light recognition device 34 and the changing device 36 may be implemented by hardware such as a large scale integrated circuit (LSI), an application specific integrated circuit (ASIC), and a field programmable gate array (FPGA), or may be implemented by matching of the software and hardware.

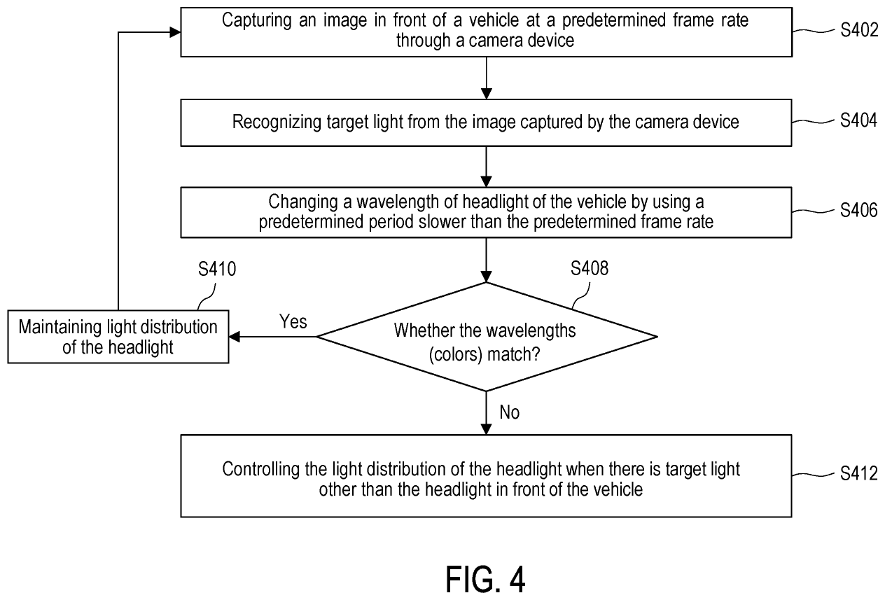

FIG. 4 is a flow chart of a headlight determination method according to an embodiment of the disclosure. With reference to FIG. 3 and FIG. 4 together, a headlight determination method provided by this embodiment is applicable to the headlight determination apparatus 30 in FIG. 3. The detailed steps of this method provided by this embodiment are described below together with the devices in the headlight determination apparatus 30.

In step S402, the headlight determination apparatus 30 captures an image in front of a vehicle at a predetermined frame rate through the camera device 32. The predetermined frame rate is, for example, 30 frames per second (fps), converted to 33.333 milliseconds (ms) per frame, but not limited thereto, and the camera device 32 may capture an image at other different frame rates.

In step S404, the target light recognition device 34 recognizes target light from the image captured by the camera device 32. Herein, the target light recognition device 34, for example, compares a wavelength (color) of headlight of the vehicle stored in advance with a wavelength (color) of the target light in the image captured by the camera device 32 to recognize the target light.

In step S406, the changing device 36 changes the wavelength of the headlight of the vehicle by using a predetermined period slower than the predetermined frame rate. In some embodiments, the changing device 36 changes the color of the headlight by changing a current value of the headlight, so that the camera device 32 may also recognize a light source of the vehicle at the current frame rate. In this case, in order not to change brightness of the headlight, conduction time of a current may be changed according to the change of the current value. Instead of changing the current value, a variable wavelength light source (RGB light source) may be used to change the color of the headlight, for example.

In step S408, the target light recognition device 34 determines whether the wavelength (color) of the headlight matches the wavelength (color) of the target light. Further, the target light recognition device 34 may also determine whether a period of the wavelength of the headlight matches a period of the wavelength of the target light.

If the wavelength (color) of the headlight matches the wavelength (color) of the target light, the target light recognition device 34 determines that the target light is reflected light from the headlight, proceeds to step S410, and maintains light distribution of the headlight. For instance, the target light recognition device 34 may not turn off a high beam or may not adjust an irradiation direction of the high beam. Further, not only the case where the wavelength (color) of the headlight matches the wavelength (color) of the target light, but also when the period of the wavelength of the headlight matches the period of the wavelength of the target light, the target light recognition device 34 may determine that the target light is the reflected light of the headlight. Further, when both the wavelengths (colors) and the periods of the wavelengths are matched, the target light recognition device 34 may determine that the target light is the reflected light of the headlight.

If the wavelength (color) of the headlight does not match the wavelength (color) of the target light, the target light recognition device 34 determines that there is target light other than the headlight in front of the vehicle, proceeds to step S412, and controls the light distribution of the headlight when there is target light other than the headlight in front of the vehicle. For instance, the target light recognition device 34 may turn off the high beam or adjust the irradiation direction of the high beam. Further, not only the case where the wavelength (color) of the headlight does not match the wavelength (color) of the target light, but also when the period of the wavelength of the headlight does not match the period of the wavelength of the target light, the target light recognition device 34 may determine that there is target light other than the headlight in front of the vehicle. Further, when both the wavelengths (colors) and the periods of the wavelengths are not matched, the target light recognition device 34 may determine that there is target light other than the headlight in front of the vehicle.

To be specific, in some embodiments, by changing the current value of the headlight through the changing device 36 and periodically modulating the wavelength (color) of the light source to a level that cannot be recognized by a user, the target light recognition device 34 may then compare the wavelength (color and/or the period of the wavelength) of the headlight of the vehicle itself with the wavelength (color and/or the period of the wavelength) of the target light in the image captured by the camera device 32, so as to determine whether the target light in the image captured by the camera device 32 is the reflection of the vehicle light source.

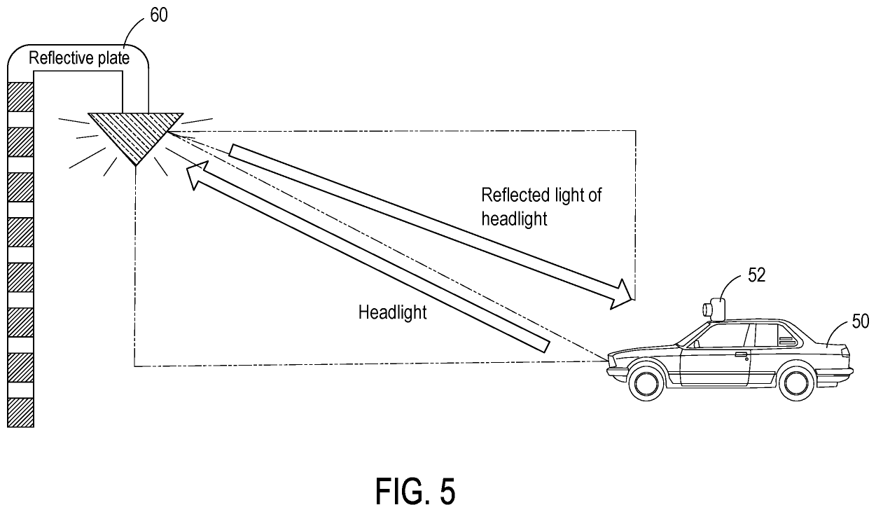

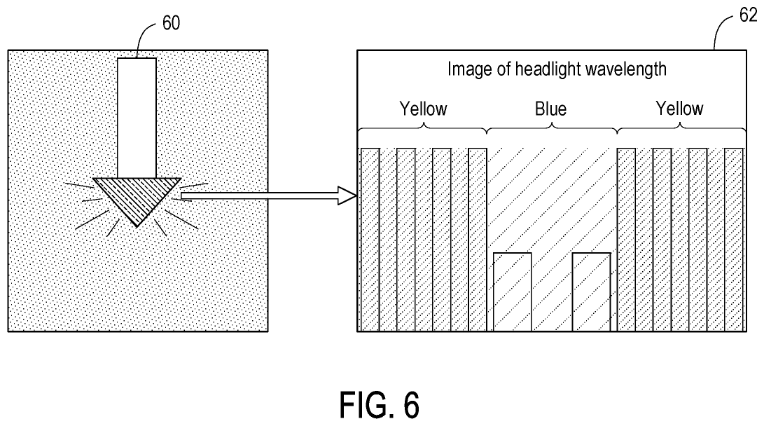

FIG. 5 and FIG. 6 are examples of the headlight determination method according to an embodiment of the disclosure. With reference to FIG. 5, in this embodiment, headlight is emitted from a headlamp of a vehicle 50 to illuminate a reflective plate 60 ahead. An image in front of the vehicle 50 including reflected light of the headlight reflected by the reflective plate 60 is captured by a camera device 52 mounted on the vehicle 50. Next, with reference to FIG. 6, an image 62 is a headlight wavelength image of the reflected light reflected by the reflective plate 60 captured by the camera device 52, and two wavelengths (colors, such as yellow and blue) that change at a predetermined period are included. Based on the fact that the vehicle 50 changes the wavelength of the headlight at a predetermined period, if the wavelength (color) of the target light contained in the image 62 matches the wavelength (color) of the headlight of the vehicle 50, and/or if the period of the wavelength of the headlight matches the period of the wavelength of the target light, it can be determined that the target light in the image 62 is the reflected light of the headlight. In contrast, if the two do not match, it can be determined that the target light in the image 62 is not the reflected light of the headlight, but light emitted by other light sources.

In some embodiments, the headlight is allowed to illuminate high beam on a wall of a factory and the like, the camera device captures the image of the wavelength (color) of the headlight, and an electronic control unit (ECU) of the camera device then stores the captured image in a storage device such as a memory of the vehicle, but not limited thereto. In other embodiments, the ECU of the camera device may also dynamically store the image of the wavelength (color) of the headlight by capturing an image of a road surface and the like reflecting the high beam of the vehicle.

In some embodiments, by changing the wavelength of the high beam, information such as the body number of the vehicle may be carried on the wavelength of the high beam of the vehicle, such that the wavelength of the headlight of each vehicle is different, so the headlight can be recognized. Alternatively, by adding a device that outputs the original wavelength (color) to the vehicle (for example, next to the front fog lamp), the wavelength of the headlight may be changed, and the headlight may be recognized. The ECU of the camera device may store the image including the abovementioned wavelength in a storage device such as a memory of the vehicle in advance, and uses it as an image for recognizing the headlight of the vehicle. By comparing the wavelength (color) stored in advance with the wavelength (color) of the currently-detected target light, when the features match, it can be determined that the target light is the reflected light of the headlight of the vehicle.

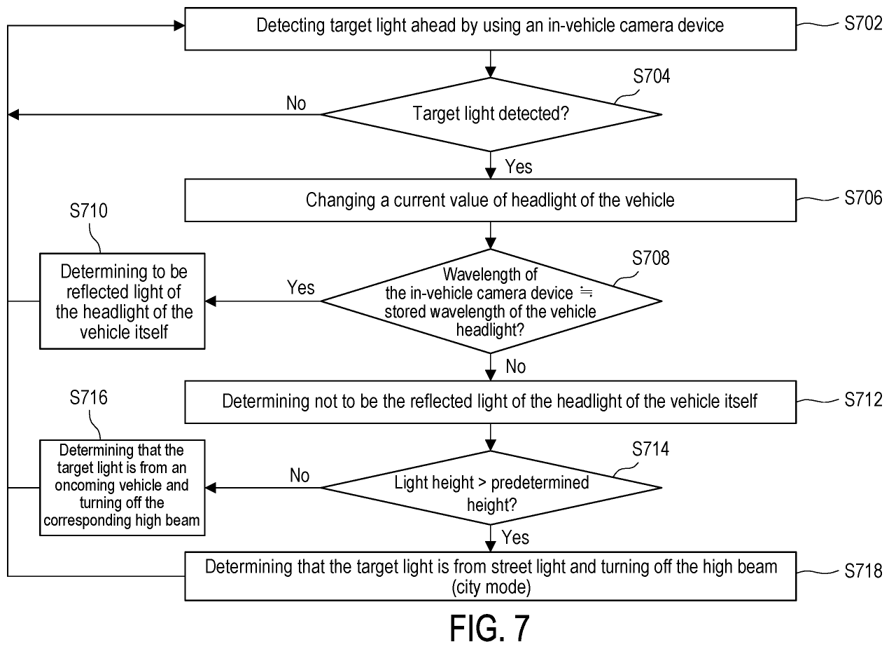

FIG. 7 is a flow chart of a headlight determination method according to an embodiment of the disclosure. With reference to FIG. 3 and FIG. 7 together, a headlight determination method provided by this embodiment is applicable to the headlight determination apparatus 30 in FIG. 3. The detailed steps of this method provided by this embodiment are described below together with the devices in the headlight determination apparatus 30.

In step S702, the headlight determination apparatus 30 detects the target light ahead by using the in-vehicle camera device 32. Herein the camera device 32 captures an image in front of the vehicle at a predetermined frame rate, for example, and detects the target light according to wavelength changes in the captured image.

In step S704, the target light recognition device 34 determines whether the target light is detected. Herein, if the image captured by the camera device 32 does not contain light of a specific wavelength, the target light recognition device 34 may determine that no target light is detected, and return to step S702 to continue detecting the target light.

In contrast, if the target light is detected, step S706 is performed, and the current value of the headlight of the vehicle is changed by the changing device 36 to change the wavelength (color) of the headlight of the vehicle using a predetermined period slower than the frame rate of the camera device 32.

In step S708, the target light recognition device 34 determines whether the wavelength of the in-vehicle camera device 32 is approximately equal to the wavelength of the vehicle headlight stored in advance. To be specific, the headlight determination apparatus 30 may obtain and store the image of the wavelength (color) of the headlight of the vehicle by capturing the image of the wavelength (color) of the headlight reflecting off the factory wall or the road surface in advance. During actual driving, the target light recognition device 34 may then read the image of the wavelength of the headlight of the vehicle to determine whether the wavelength in the image captured by the in-vehicle camera device 32 is equal to the wavelength of the headlight of the vehicle stored in advance.

If the wavelength of the in-vehicle camera device 32 is approximately equal to the wavelength of the headlight of the vehicle stored in advance, then in step S710, the target light recognition device 34 determines that the detected target light is the reflected light of the headlight of the vehicle itself, and therefore does not change the light distribution of the headlight, returns to step S702, and continues to detect the target light.

In contrast, if the wavelength of the in-vehicle camera device 32 is not equal to the wavelength of the headlight of the vehicle stored in advance, then in step S710, the target light recognition device 34 determines that the detected target light is not the reflected light of the headlight of the vehicle itself and proceeds to step S714 to determine whether a light height of the target light is greater than a predetermined height. The predetermined height is set, for example, according to the height of street light, so as to distinguish whether the target light comes from a street lamp or from an oncoming vehicle.

If the light height of the target light is not greater than the predetermined height, then in step S716, the target light recognition device 34 may determine that the target light is from an oncoming vehicle and turns off the corresponding high beam. Herein, the target light recognition device 34 may use an auto high beam (AHB) technology to turn off the high beam or use an adaptive driving beam (ADB) technology to adjust the light, so as to prevent the high beam from irradiating the driver of the oncoming vehicle and causing glare, but it is not limited thereto. The target light recognition device 34 may select an appropriate way to turn off or adjust the high beam according to the actual situation.

If the light height of the target light is greater than the predetermined height, then in step S718, the target light recognition device 34 may determine that the target light is from street light and turns off the high beam (city mode). That is, in bright urban areas with more street lamps, the target light recognition device 34 may automatically turn off the high beam, so that the high beam may be prevented from irradiating pedestrians.

After the high beam is turned off, step S702 is performed again, and the target light continues to be detected to determine whether the high beam is to be turned on again.

Through the above method, the headlight determination apparatus 30 may determine whether there is target light in front of the vehicle from the image captured by the in-vehicle camera device 32 and then determines whether the target light is reflected light from the headlight of the vehicle itself, from an oncoming vehicle, or from a street lamp. The headlight determination apparatus 30 then adaptively adjusts the on/off of the high beam, the irradiation range, etc., so as to prevent the high beam from irradiating the driver of the oncoming vehicle or the pedestrians.

In some embodiments, the headlight determination apparatus may obtain the unique wavelength of the street light in advance and register it in the storage device such as the memory of the vehicle to distinguish a street lamp from a reflective object on the road. For instance, the headlight determination apparatus may compare the wavelength in the image captured by the camera device with the unique wavelength of the street light, and if the comparison result shows that the two do not match, it can be determined that the detected target light is not street light but a reflective object on the road.

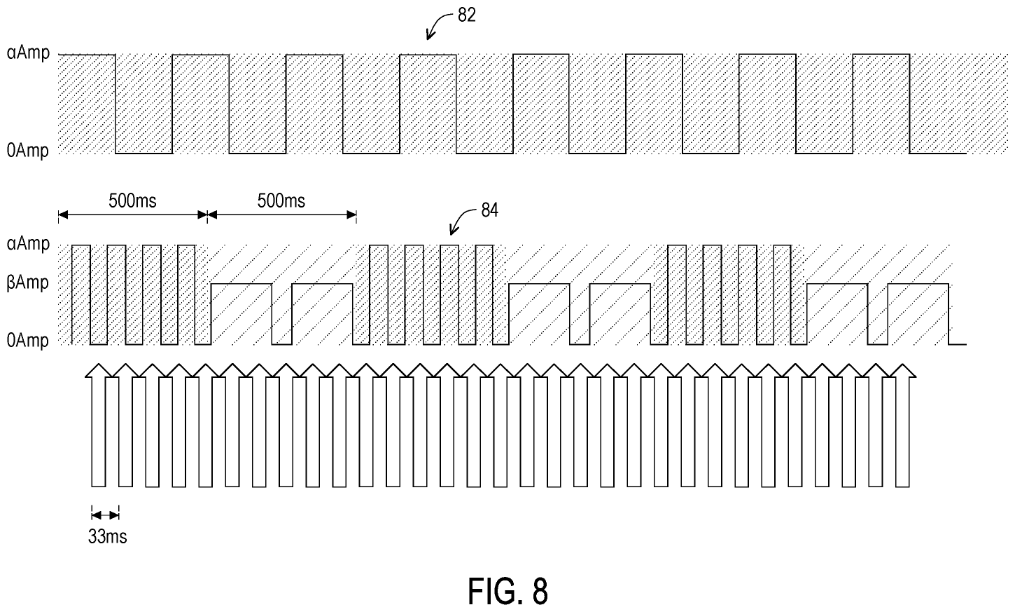

For instance, FIG. 8 is an example of distinguishing street light and a reflective object according to an embodiment of the disclosure. With reference to FIG. 8, in this embodiment, an image 82 is, for example, an image of the wavelength of the street light recorded in the ECU of the camera device, where the wavelength in the image 82 is also fixed based on the color of the street light being fixed. An image 84 is then an image of the wavelength of the headlight reflecting off a reflective object (e.g., an arrow-feather traffic sign) on the road, where the wavelength of the headlight is changed, resulting in a color change. The headlight determination apparatus may distinguish whether the detected target light is from street light or from a reflective object by comparing the color of the headlight and the color of the street light. As shown in the figure, compared to the wavelength (color) of the headlight changing at a period of 500 milliseconds, the camera device may use a period of 33 milliseconds to obtain an image. Therefore, a sufficient comparison may be made to accurately distinguish between the street light and a reflective object.

In view of the foregoing, in the disclosure, the headlight determination apparatus may recognize whether there is target light other than the headlight in front of the vehicle by changing the wavelength of the headlight of the vehicle and comparing it with the wavelength of the target light in the image which is captured in front of the vehicle, and accordingly controls the light distribution of the headlight. By detecting the change in color, the reflected light of the headlight of the vehicle itself can be distinguished from other light sources even if the frame rate of the camera device is slower than the headlight change period.

Although the disclosure has been disclosed above with the embodiments, the embodiments are not intended to limit the disclosure. A person having ordinary skill in the art may make alternations and modifications without departing from the spirit and scope of the disclosure. Therefore, the protection scope of the disclosure should be defined by the attached claims and their equivalent scope.

What is claimed is:

1. A headlight determination apparatus, comprising:
a camera device configured to capture an image ahead of a vehicle at a predetermined frame rate;
a target light recognition device configured to recognize target light from the image captured by the camera device; and
a changing device configured to change a wavelength of headlight of the vehicle by using a predetermined period slower than the predetermined frame rate, wherein
when the wavelength of the headlight is different from a wavelength of the target light and/or when a period of the wavelength of the headlight does not match a period of the wavelength of the target light, the target light recognition device determines that there is target light other than the headlight in front of the vehicle and controls light distribution of the headlight when there is target light other than the headlight in front of the vehicle.

2. The headlight determination apparatus according to claim 1, wherein
the changing device changes a color by changing a current value of the headlight.
